(19) United States
(12) Patent Application Publication
(10) Pub. No.: US 2024/0306259 A1
(43) Pub. Date: Sep. 12, 2024

(54) SYSTEMS FOR ARTIFICIALLY FORMING CLOUDS, RELOCATING FORMED CLOUDS AND METHODS OF USING SAME

(71) Applicant: G POWER PLANTS DMCC, Dubai (AE)

(72) Inventor: Shafi Quraishy, Dubai (AE)

(21) Appl. No.: 18/601,576

(22) Filed: Mar. 11, 2024

Related U.S. Application Data
(60) Provisional application No. 63/451,456, filed on Mar. 10, 2023.

(51) Int. Cl. H05B 1/00

(52) U.S. Cl. CPC H05B 1/00

(57) ABSTRACT

The current invention describes a system and method for relocating densely formed clouds from the location they are formed to another pre-determined and desired location. This is achieved by using air vehicles, or stationary air pods, to change the temperature of the desired location by increasing such temperature. This in tun creates a low-pressure system in that location, which acts as a sink to the air surrounding that location. Such low pressure causes the clouds to be drawn to the low-pressure system, thereby manufacturing the movement of the clouds from the position it was originally formed to another predetermined position. Other aspects of the invention describe a system for forming clouds from sea water or other bodies of water, using a mechanism to allow for utilizing solar energy to achieve the evaporation process faster than the natural process.

### INCORPORATION BY REFERENCE

This application is a US non-provisional patent application, which claims priority from U.S. Provisional Patent Application No. 63/451,456, filed on Mar. 10, 2023 and entitled “A System for Producing Clouds and Triggering Rainfall at a predetermined Location and a Method of Using Same”, the entirety of which is hereby incorporated by reference.

### TECHNICAL FIELD

This invention relates generally to a system and method for cloud forming and control and more particularly, to systems for artificially forming clouds, relocating formed clouds to a predetermined location and methods of using same.

### BACKGROUND

Many countries experience very hot weather and scarce natural rainfall such as countries in the middle east. Several countries, including the UAE, are looking for a solution to increase rainfall and accordingly increase the sources of drinking water. Currently these countries are relying on desalination of sea water as their usable water resource. The desalination technology which is used currently needs a lot of energy and fuel making the process very expensive.

The middle east region is abundant in solar energy and sea water. Rainwater works differently in nature than water from the irrigation supply. Rainwater can enrich the land and soil quality to make it useful for agriculture compared to water obtained from just irrigation. The rainwater also can make a difference in the climatic conditions in that particular region. Irrigation will only allow the water to be supplied to a limited area. Furthermore, the process and the infrastructure required for irrigation is expensive.

There are technologies available to create rain from existing clouds. One such example is the seeding of naturally formed dense clouds, which are moisture filled clouds. In such technique, silver iodide particles are released into the clouds to allow for droplets of the supercooled water to form crystals around the silver iodide particles, which allows for forming of raindrops and rain fall, or snowflake formation and snow fall. However, cloud seeding relies on the existence of dense clouds. In other words, when there is sufficient evaporated water content available in the sky. Additionally, cloud seeding is limited to the location where such clouds are formed.

There is a desire in the field for a solution that addresses at least some of the issues identified above.

### SUMMARY OF THE INVENTION

The current invention includes several aspects. One aspect of the invention describes a system for relocating clouds from an original location in the atmosphere to a predetermined location in the atmosphere. The system includes a device having a power source and a heating mechanism powered by the power source and configured to heat the predetermined location in the atmosphere to a temperature higher than temperatures in locations neighboring the predetermined location, thereby creating a low pressure system in the predetermined location in the atmosphere compared to the original location of the clouds. The low pressure system causes the clouds to move from the original location to the predetermined location in the atmosphere.

In a related embodiment, the device is one or more air vehicles. Each of the one or more air vehicles comprises one or more sensors for measuring a temperature, where the device is located, measuring an elevation of the device, and determining the special coordinates of the device in the atmosphere using the global positioning system (GPS).

In a further related embodiment, the system further comprises a processor in data communication with the one or more sensors. The processor is powered by a power supply and has a storage device, on which measurements from the one or more sensors are stored and accessible by the processor. The storage device may be integral or external to the processor. The processor may be located on the device or placed remotely to it. The processor is configured for mapping a path of movement of the clouds from the original location to the predetermined location in the atmosphere based on data collected from the one or more sensors. The mapping may also integrate additional data including but not limited to heat maps of the area, wind direction and speed as well as air pressure of the area.

In a further related embodiment, the path of movement of the clouds from the original location to the predetermined location in the atmosphere includes one or more nodes, wherein the one or more sensors are configured to obtain sensory data at each of the one or more nodes and wherein the device is configures to create a low pressure system at each of the one or more nodes, when the device is positioned at the one or more nodes, thereby causing the clouds to move from the original location to the predetermined location incrementally along each position of the one or more nodes.

In another related embodiment, the device in the system is a plurality of air vehicles forming a constellation, wherein all air vehicles in the constellation are synchronized to work in unison to establish a low pressure system sufficient in size to move the clouds from the original position to the predetermined position. In such embodiment, the constellation may take any configuration such as a cluster for example.

In yet another related embodiment, the device is a plurality of air vehicles forming a constellation, wherein each air vehicle in the constellation is configured to occupy a position of the one or more nodes and wherein all air vehicles in the constellation are synchronized to work in unison to establish a low pressure system sufficient in size to move the clouds incrementally from the original position to the predetermined position along the path formed by the one or more nodes.

In a related embodiment of the original system, the device is a series of stationary pods forming a grid structure, wherein each pod in the stationary pods is suspended in a predetermined pod location in the atmosphere and wherein each pod comprises one or more sensors for measuring a temperature, where the pod is located.

In a related embodiment to the preceding embodiment, the system further comprises a processor in data communication with the one or more sensors in each of the pods. The processor is powered by a power supply and has a memory storage device, on which measurements from the one or more sensors from each pod are stored and accessible by the processor. The processor is configured for mapping a path of movement of the clouds from the original location to the predetermined location in the atmosphere based on data collected from the one or more sensors from each of the pods. The path of movement of the clouds from the original location to the predetermined location in the atmosphere includes one or more nodes corresponding in special location to some of the stationary pods in the constellation of pods.

In another aspect of the invention, a system for forming clouds in the atmosphere artificially is described. The system comprises a water container for housing water; at least one lens positioned above the water container for concentrating sunrays on at least part of the surface of the water container and heating the water inside the water container to convert the water to steam; and a steam channel fluidically coupled to the water container, the steam channel configured to allow the steam generated in the water container to escape to the atmosphere. The clouds are artificially formed in the atmosphere on demand by the steam escaped from the steam channel.

In a related embodiment of the cloud forming system, the at least one lens is supported by a lens frame, the system further comprises controls for controlling elevation and orientation of the lens frame either manually or automatically through a processor operated by instructions stored on a memory storage device. The controls mounted on a structural frame for supporting the controls, the lens frame and the at least one lens above the water container.

In a further related embodiment to the preceding embodiment, the system further comprises an inlet channel fluidically coupled to the water container and is configured for supplying the water from a water reservoir to the water container. The system further comprising an inlet pump for pumping the water from the water reservoir to the water container.

In a further related embodiment to the preceding embodiment, a heating unit is defined to have the water container, the at least one lens, the lens frame and the structural frame, and the system comprises a plurality of heating units.

In a further related embodiment to the preceding embodiment, the system further comprises a network of secondary channels configured to fluidically couple all of the water containers in the plurality of heating units in the system. The connection of the secondary channels may be such that the water containers are coupled in series to one another or in parallel to the water reservoir or any combination of the above.

In a related embodiment to a previous embodiment of the second aspect of the invention, the cloud forming system further comprises a desalination unit. The desalination unit comprises a desalination channel, a cooling chamber and a desalinated water container, wherein the desalination channel directs the steam from the water container to the cooling chamber for condensing the steam into water, and wherein the condensed water is stored in the desalinated water container.

In a related embodiment to a previous embodiment of the second aspect of the invention, the cloud forming system further comprises a steam turbine housed in a compartment that is fluidically coupled to the steam channel and wherein the steam is passed through the steam turbine before escaping to the atmosphere, thereby generating electricity.

In a related embodiment to a previous embodiment of the second aspect of the invention, the cloud forming system further comprises a lens cover configured for covering the at least one lens and shielding the at least one lens from sunrays, thereby stopping heat access to the water container. The operation of such cover may be manual or automatic through the use of a processor, that could be the same or a different processor used to control other aspects of the sysem.

In a related embodiment to a previous embodiment of the first aspect of the invention, the cloud relocating system may be used with naturally formed clouds or clouds that are artificially formed according to any of the embodiments described in the second aspect of the invention.

In another aspect of the invention, a method of relocating clouds in the atmosphere from an original position to a predetermined position in the atmosphere is described. The method comprises heating the predetermined positing in the atmosphere to a temperature higher than temperatures of neighboring positions in the atmosphere, including the original position; and creating a low pressure system at the predetermined position, the low pressure system causing the clouds to move from the original position to the predetermined position.

In a related embodiment to the preceding embodiment, the method further comprises mapping a path of movement of the clouds from the original position to the predetermined position in the atmosphere based on sensory data relating to temperature, elevation and positioning of the original position and the predetermined position.

In a further related embodiment, the mapping of the path of movement of the clouds comprises mapping one or more nodes along the path of movement and incrementally moving the clouds from the original position to the predetermined position along the one or more nodes by creating a low pressure system at each one of the one or more nodes.

Other aspects and embodiments of the invention will be apparent as will be shown in the detailed description of the invention.

### BRIEF DESCRIPTION OF THE DRAWINGS

The accompanying drawings illustrate non-limiting example embodiments of the invention.

FIG. 1 shows a perspective view of a cloud forming system according to an embodiment of the invention.

FIG. 2 shows a perspective of the water container and heating unit of the system shown in FIG. 1.

FIG. 3 shows a perspective view of a variation of the cloud forming system, having multiple water container and heating units.

FIG. 4 shows a partial side view of the embodiment shown in FIG. 3.

FIG. 5 shows a partial perspective view of the embodiment of FIG. 3.

FIG. 6 shows another perspective view of FIG. 5.

FIG. 7 shows a side view of the water repository unit of the system in FIG. 1.

FIG. 8 shows another partial perspective view of the water container and the heating unit of the system in FIG. 3.

FIG. 9 shows another perspective view of the system in FIG. 3.

FIG. 10 shows a side view of the system in FIG. 3.

FIG. 11 shows another perspective view of the system in FIG. 3.

FIG. 12 shows a perspective view of an embodiment have a field of cloud forming systems, each raw in the field corresponding to the system described in FIG. 3.

FIG. 13 shows another perspective view of the system in FIG. 12.

FIG. 14 shows a schematic view representing the cloud relocating system according to an embodiment of the invention.

### DETAILED DESCRIPTION

Throughout the following description, specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

Naturally, the heat from the sun causes evaporation of the surface of water bodies. Clouds form when the invisible water vapor in the air condenses into visible water droplets or ice crystals. For this to happen, the parcel of air must be saturated, i.e. unable to hold all the water it contains in vapor form, so it starts to condense into a liquid or solid form. This causes rain fall or snow fall in the location, where the clouds are formed. In some regions, cloud formation is common over certain locations leaving other locations dry. The current disclosure addresses this problem by providing a system for relocating densely formed clouds from the location they are formed to another pre-determined and desired location. This is achieved by using air vehicles, such as drones for example, to change the temperature of the desired location by increasing such temperature. This in tun creates a low-pressure system in that location, which acts as a sink to the air surrounding that location. Such low pressure causes the cloud to be drawn to the low-pressure system, thereby manufacturing the movement of the cloud from the position it was originally formed to another predetermined position different from the first position.

Other aspects of the invention describe a system for forming clouds from sea water or other bodies of water, using a mechanism to allow for utilizing solar energy to achieve the evaporation process faster than the natural process. The system also allows for relocating the formed clouds to a predetermined and desired location, that is different from the location the clouds where formed, either naturally or via the use of aspects of the current invention.

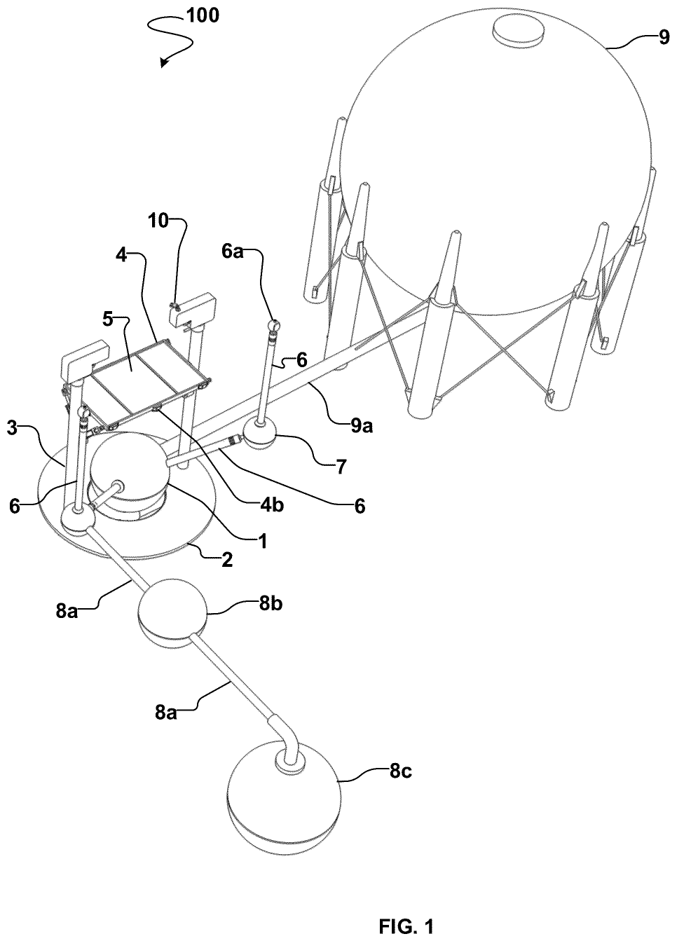

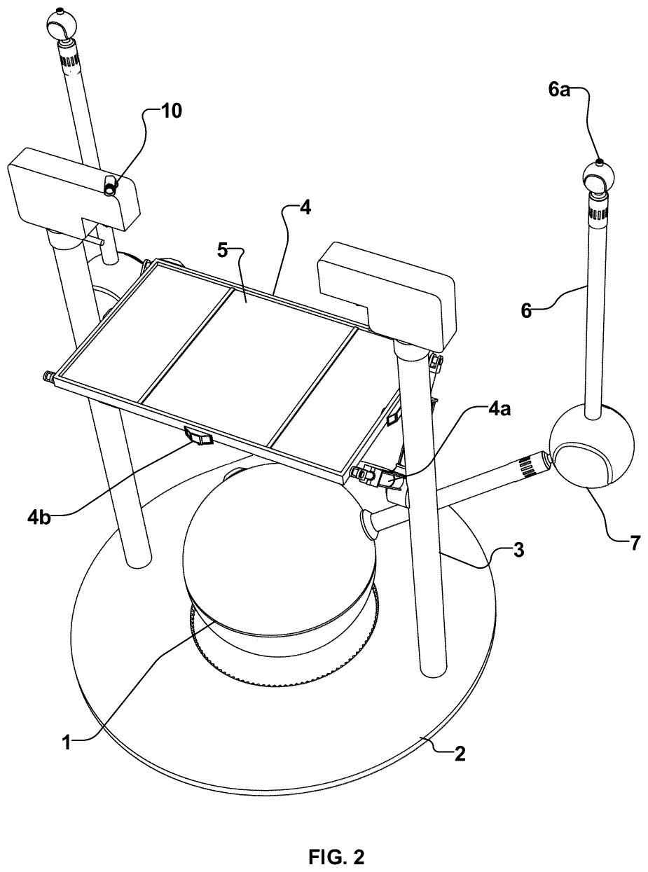

FIG. 1 and FIG. 2 show a system according to an embodiment of the invention, for forming clouds on demand, using solar energy for heating a body of water to generate steam, which in turn is released to the atmosphere to form clouds. FIG. shows a perspective view of system 100 according to an embodiment of the invention. System 100 includes a water container 1 for housing the water body, which will be heated. Water container 1 is shown in FIG. 1 to have a spherical shape for maximizing the surface area for heat exposure. However, it is to be understood that such shape is only exemplary and that other shapes may be used. Also, it is to be understood that the size of the water container may vary depending on the volume of cloud production desired as well as the size of the body of water reservoir that supplies water to the system. In the current example embodiment, water container 1 is a closed container. Also, at least the upper surface of the container is made from material with high melting point, a low thermal coefficient of expansion and good thermal conductivity. A non-limiting example of such material is tungsten.

FIG. 1 also shows platform 2, on which frame 3 is mounted for holding a lens frame 4, which in turn is used to hold and secure lens 5. Frame 3 and lens frame 4 may be made from any material known in the industry, suitable for their function. Frame 3 and lens frame 4 may be made from the same or different material. Lens 5 may be made from one piece or multiple pieces, such as shown in FIG. 1. In the example embodiment shown in FIG. 1, lens 5 is a Fresnel lens used for concentrating solar light and energy to the surface of water container 1. Lens 5 is shown to be held above water container 1. The position and orientation of lens 5 relative to water container 1 is controlled by controlling arms 4a and is monitored by sensors 4b and 10. Specifically, the elevation of lens 5 relative to water container 1 is determined using sensors 4b and so that the focal point of the light refracted through lens 5 is focused on the surface of water container 1. Sensors 10 may also be used to visually monitor the surface of lens 5 and provide visual detection of any debris or obstacles on same. Additionally, the orientation (tilting) of lens 5 is also controlled by arms 4a, which is used to maximize the surface area of lens 5 relative to the direction of the solar rays, while also maintaining the focal point of refraction on at least part of the surface of water container 1.

Controlling arms 4a may be configured to be controlled manually through a control interface (not shown). Controlling arms 4a may also be controlled automatically through the use of a processor (not shown). In the latter case, the processor may be configured to receive elevation sensory data from sensors 4b and 10, either through wireless or wired communication. Data relating to the time of day and the position of the sun relative to the earth and specifically relative to a certain point on earth, representing the position of the platform, may be stored in a memory storage device, which is accessible by the processor. Such memory device may be integral or external to the processor. Series of instructions may be stored on the memory storage device that are accessible by the processor. When such instructions are executed by the processor, the processor causes the control arms 4a to adjust the elevation and orientation of lens frame 4 to maximize solar exposure to the surface of lens 5 and to focus such solar energy on at least a part of the upper surface of water container 1.

In some embodiments (not shown), the elevation of the lenses relative to the water container may be fixed and multiple lenses may be used with each one having a fixed different orientation to allow for maximizing solar ray exposure for at least some of the lenses at different times of the day. In such embodiment, the controlling arms and the elevations sensors may be optional.

In FIG. 1, channels 6 are shown to be extending from water container 1. Channels 6 are configured to allow for the flow of steam out of water container 1, once the container is heated and the water therein is converted to steam. As such, channels 6 provide an escape of the steam to alleviate the pressure build up inside water container 1 once the water is converted to steam. In the example embodiment shown, two channels 6 are shown to extend from water container 1. However, it is to be understood that this is exemplary and that the number of channels may be 1 or more, depending on the size of the container as well as the width and length of the channel. The material the channels are made from may be any material known in the art for such function.

FIG. 1 shows channel 6 composed of two channel parts (both references as channel 6), with one pointed upwards to allow for the steam to escape to the atmosphere. In other embodiments, channel 6 may be composed of a singular channel, where one end is connected to the water container and the other end is pointed upward or substantially upward to allow the steam to escape to the atmosphere. In FIG. 1, the end of channel 6 pointed upward is shown to have a mechanism configured to control opening 6a to block the opening when steam is not escaping the channel to prevent debris and rain/snow, etc. from entering the channel. The mechanism used also unblocks the opening when steam is escaping channel 6. Different mechanisms known in the art may be used for this purpose, including but not limited to the use of a flap that sits on the opening and blocks it when no steam is escaping the channel through the opening; and when steam is flowing in the channel, the flap is pushed upward by the steam to open the channel opening allowing the steam to escape the channel. In other embodiments, such mechanism may be controlled by the same or different processor that controls the lens frame movement. In such embodiment, sensors may be provided in the channels 6 or container 1 to detect the heat and moisture and such sensory information is communicated to the processor, which based on same may control the opening and closing of the mechanism controlling opening 6a of channel 6 to allow for the escape of steam, when generated in water container 1.

In FIG. 1, an additional optional component 7 is provided across the steam path in channels 6. Such component may comprise a steam turbine, which allows for harvesting the energy in the steam and converting same to electricity. Such electricity may be used for any purpose including supplementing external power sources used for pumping water into container 1.

FIG. 1 also shows another optional feature in the system, which is configured for water desalination and the generation of drinkable water. The desalination mechanism is shown to include channels 8a, which are corrected to component 7, housing the steam turbine. In other embodiments (not shown), where the steam turbine is not present, channel 8a may be connected directly to an opening in water container 1, independent from channel 6. Channel 8a is shown to be connected on its other end to a cooling chamber 8b, in which the steam from water container 1 is cooled and converted to water, which is then directed through another extension (also referenced as channel 8a) to container 8c for storage of the cooled water. Different passive and active cooling techniques known in the industry may be applied.

In some embodiments, channel 8a and channel 6 may be controlled by valves (not shown) that are configured to open and close such channels. Such valves may be, for example, manually or automatically controlled to close channel 8a and open channel 6, when it is desired to make clouds. In other circumstances, when it is not desired to make clouds, the valves controlling channel 6 may be closed and the ones controlling channel 8a may be open to allow for the desalination process only. In other embodiments, channel 6 and channel 8a may be open to allow for the cloud forming process and the desalination process to be operational at the same time. The automation of the control of the valves may be achieved through the same processor used to control the lens frame 4 and/or the opening and closure of opening 6a.

In the embodiment in FIG. 1, water supply to water container 1 is shown to be provided through pipe or channels 9a, which is in turn connected to a water reservoir container 9. Pumps (not shown) may be used to pump water from water reservoir 9 to water container 1 through channel 9a. In some embodiments, water reservoir 9 may be a natural body of water such as sea water or a river in proximity of the system 100 and pumps (not shown) may be used to pump water from such water reservoir source to water container 1.

In some embodiments, the water container may be open from the top to allow the water therein to be exposed to the elements. The lens in such embodiments may be angled not to be directly above the water container but still oriented to direct the solar light to at least part of the surface of the water in the water container. This causes the water in the water container to eventually boil and convert to steam, which is released to the atmosphere directly. In such embodiments, channels 6 may not be required.

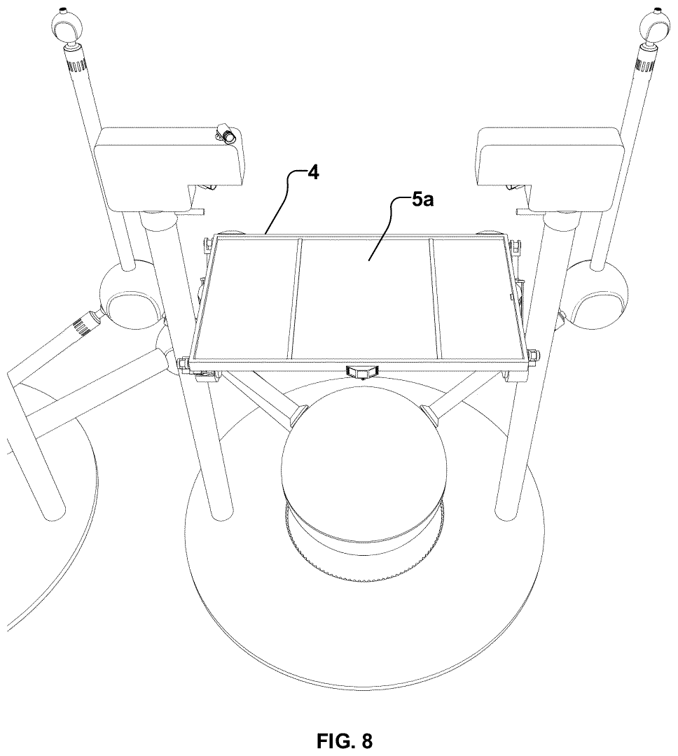

In some embodiments, Lens 5 may be covered by cover 5a to shield it from direct exposure to sunlight. The cover 5a (shown in FIG. 8) may be utilized at times when the system is not to be used, when water supply is below a pre-determined level, or during maintenance, among other reasons. Covering the lens is done for safety since heating the container surface without water inside or without a minimum level of water inside may cause the excessive heat to damage the equipment, including the valves, channels as well as the structural integrity of the system as a whole. The lens cover may be deployed manually through an interface or automatically. In the latter case, a processor may be configured to deploy the lens cover based on various factors, including status of operation, weather conditions, and water levels. The processor may be the same or different processor than the one controlling the lens frame, opening 6a and/or channels 6 and 8a. The processor may also deploy the cover to cover the lens based on temperature readings inside the water container. Specifically, to ensure that operation of the system is maintained within safety levels, a maximum temperature inside the container may be set. If such temperature is reached, the processor may be configured to cover the lens, which in tun, indirectly, shields the water container from the heat source in the system and prevents the temperature inside the water container from raising past the pre-determined temperature. Such operation may also be implemented on a manual level in case of emergencies or the like. In some embodiments, the lens may be oriented to be substantially vertical to the container. In such orientation, the lens will not be used to focus sunrays on any part of the water container and thereby, will not act in such orientation as a heat source for the system.

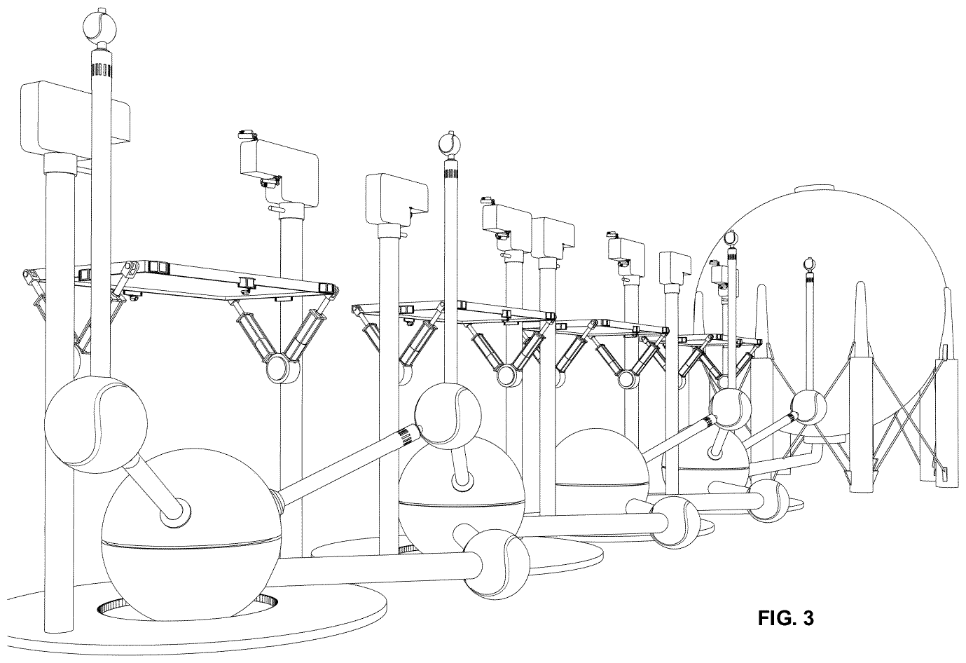

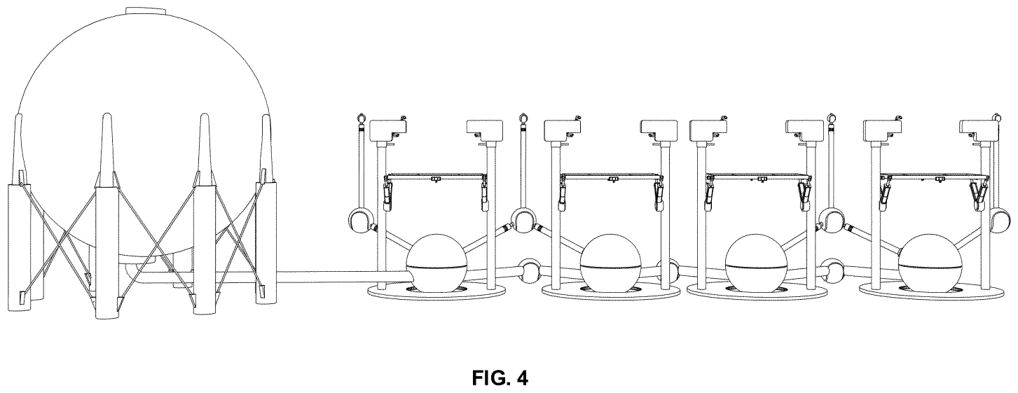

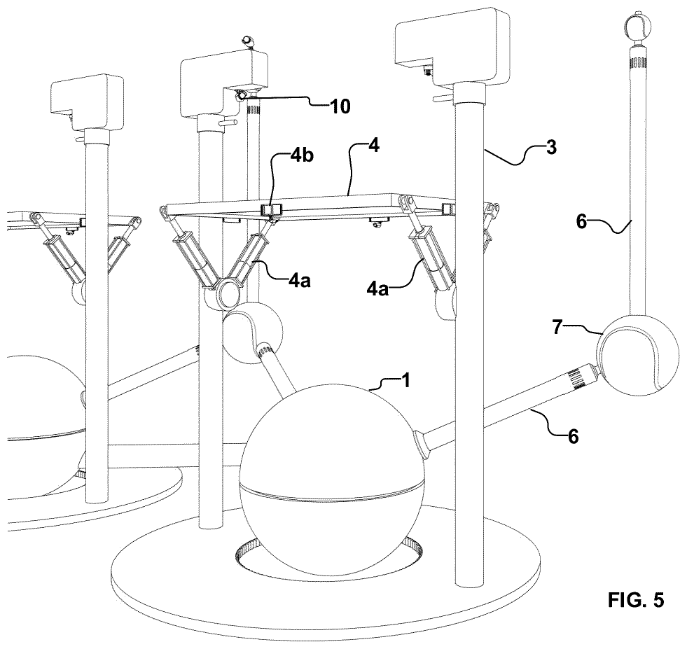

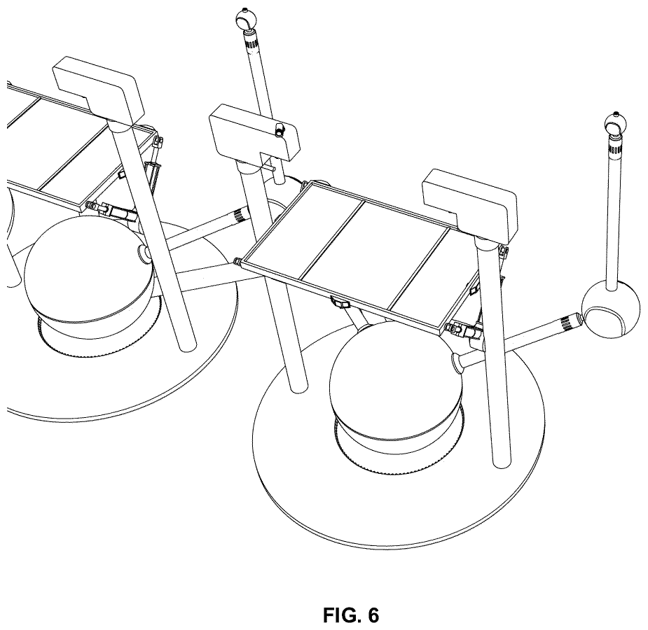

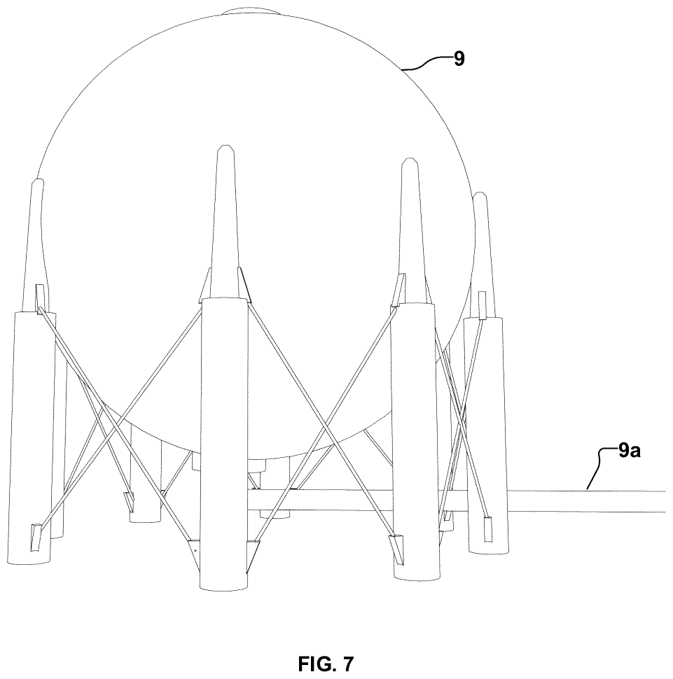

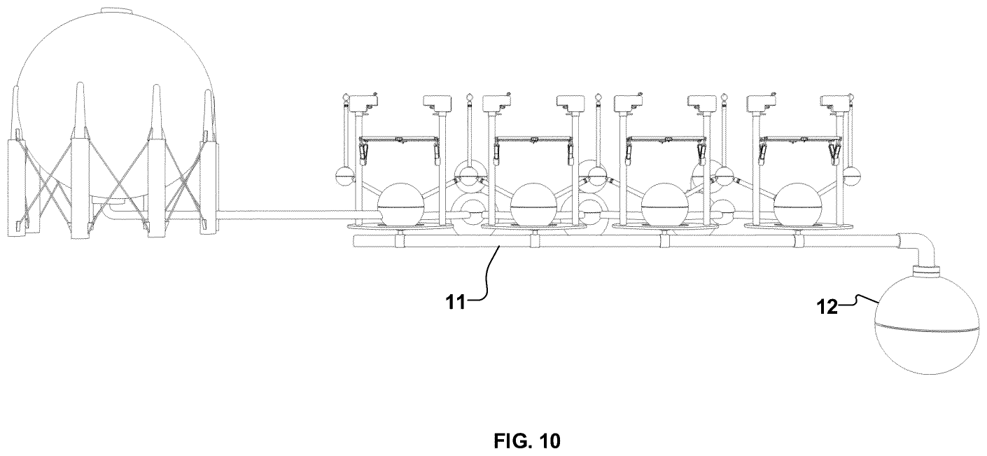

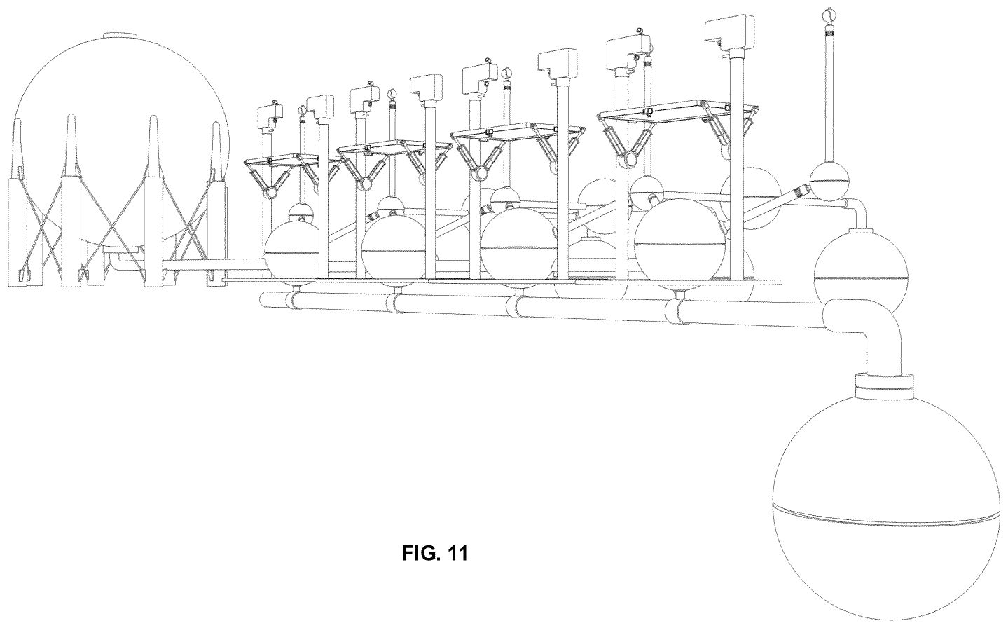

System 100 shows one water container 1. In some embodiments, the system may include multiple steam generating/desalination units and electric power generators. Each unit will be similar in construction to that described in FIGS. 1 and 2, each of them acting as a unit for converting water to steam and releasing that steam to the atmosphere. Examples of such system are provided in FIG. 3 to FIG. 11, which show a system of multiple water containers 1 connected to each other via channels 9b that allow for the water to flow from the first container that is connected to the water reservoir to the rest of the water containers. In the example provided in the figures, water from the reservoir is pumped to the first water container 1 through channel 9a. Channel 9b connecting the first water container to the second water container allows water to flow from the first water container 1 to second water container 1 to fill the second water container. The same step is repeated between the second water container 1 and the third water container 1 in that configuration and between each two consecutive containers connected to each other by channel 9b. In such process, the water level in each of water containers in the system will be eventually filled to the same level. Ideally, each water containers 1 in the system would be filled to a predetermined level before the heating system is utilized. Connection 9a and reservoir 9 allow for a continuous supply of water to water containers 1 during operation of the system. In some embodiments, it is possible to restrict the water flow to one or more containers at the end of that sequence described. This, for example, may be done if any of such water containers 1 or any parts connected to them require maintenance, replacement or repair or if the water supply from water reservoir 9 is not sufficient to fill all water containers 1 to the pre-determined level. In such circumstances, the lens for any unused water containers would be covered to shield it from exposure to sunrays.

The plurality of water heating units shown in FIGS. 3 to 11 are shown to be connected to each other in series. In some embodiments (not shown) each unit may be connected directly to the water reservoir through its water supply channel. In such embodiments, channels 9b may not be required. Also, in such configuration of the system, the control of water supply from the reservoir to the water container would be in each channel 9a from the reservoir to that particular container and the control of the covers to the lens covering such water container would be in sync with same.

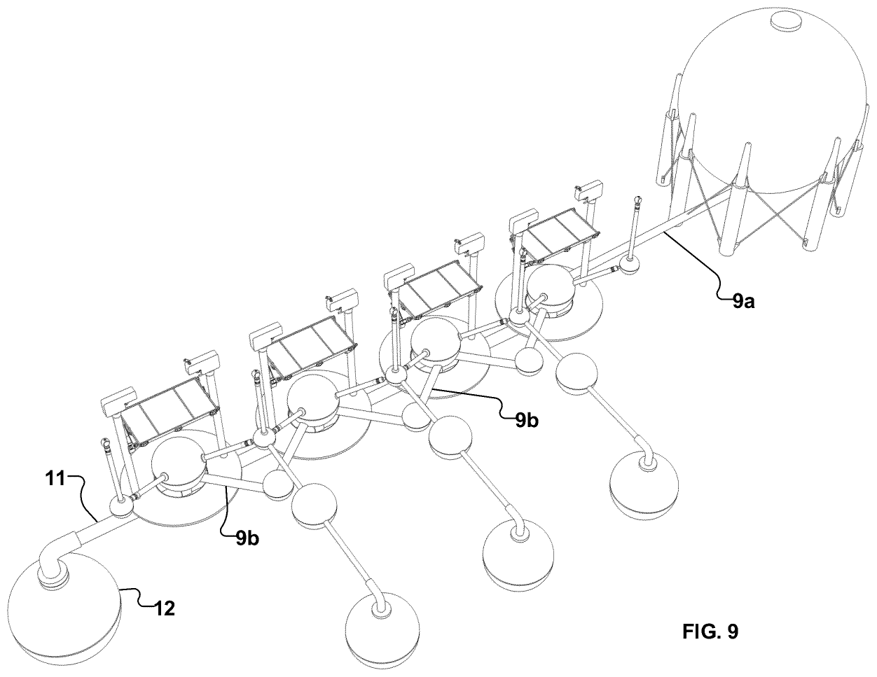

FIGS. 9, 10 and 11 show different views of the system having multiple water heating units connected in series. In the figures, a sub-platform channel 11 is shown to be connected to each of the water containers 1. Such channel is designed for collection of salts residue that remain after converting the water to steam inside water container 1. Such salts are collected from the water containers by allowing the salt to fall from the water container to channel 11 through a designated closable opening. Such opening may be controlled manually or automatically to allow the salts to be retrieved from the water containers and to minimize the escape of any steam through such opening. Channel 11 is shown to terminate in a salt retrieving container 12. The salt in channel 11 once deposited from each of the water containers 1 may be directed to container 12 using different means known in the fields for such purpose. This may include for example, the use of soluble or air or other techniques known in the field. The salt in the salt container may in itself act as a heat storage unit, which may be utilized for different purposes. In an alternative embodiment, each water heating unit may have a salt container positioned beneath it for collecting the by-product salts remaining after converting the water into steam inside the water container. In such embodiment, channel 11 may not be required.

In some embodiments, system 100 may be placed on land in close proximity of a natural body of water such as a sea or a river. This allows for easy access to the water reservoir needed to continuously supply water to the system during its operation. The location of the system 100 may be away from one or more natural bodies of water but in such circumstance, other means known in the field will be required to be put in place to allow for the desired supply of water to the water containers in the system during its operation. In such embodiment, the duration and frequency of operation of the system may be limited based on the supply of the water to the water containers in the system. In other embodiments, the system may be placed on top of a body of water. In such embodiments, the water container may be positioned to be above and separate from the body of water so that the heat absorbed by the water container during operation does not substantially affect the temperature level of the natural body of water underneath it. The purpose of such configuration is to avoid negatively impacting the temperature level of the natural body of water, which may negative impact the marine ecosystem within such body of natural water. In such embodiment, platform 2 may be configured to float on the surface of the body of water or may be elevated above it. Ankers (not shown) may be used in such embodiment to fix the platform in position relative to the body of water underneath it.

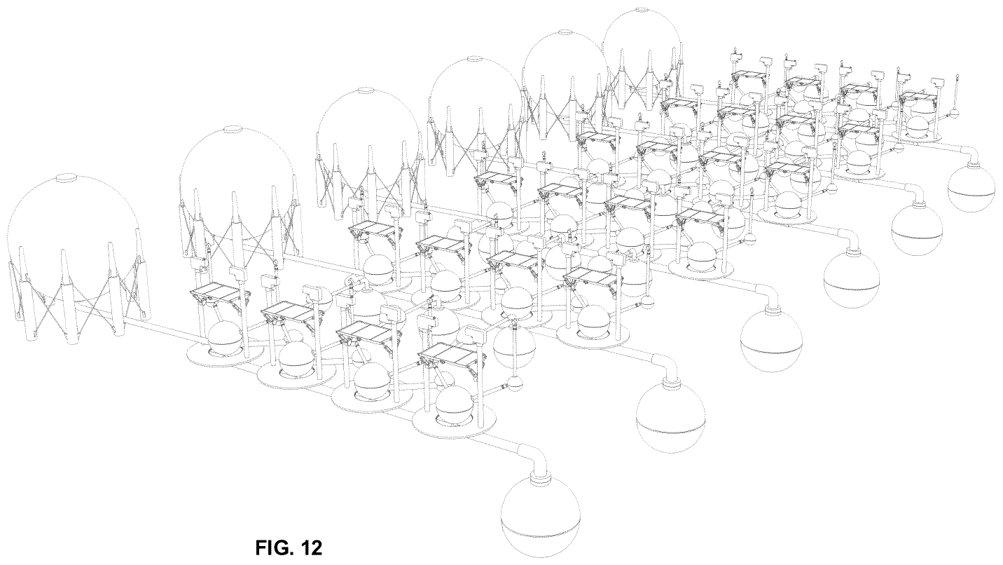

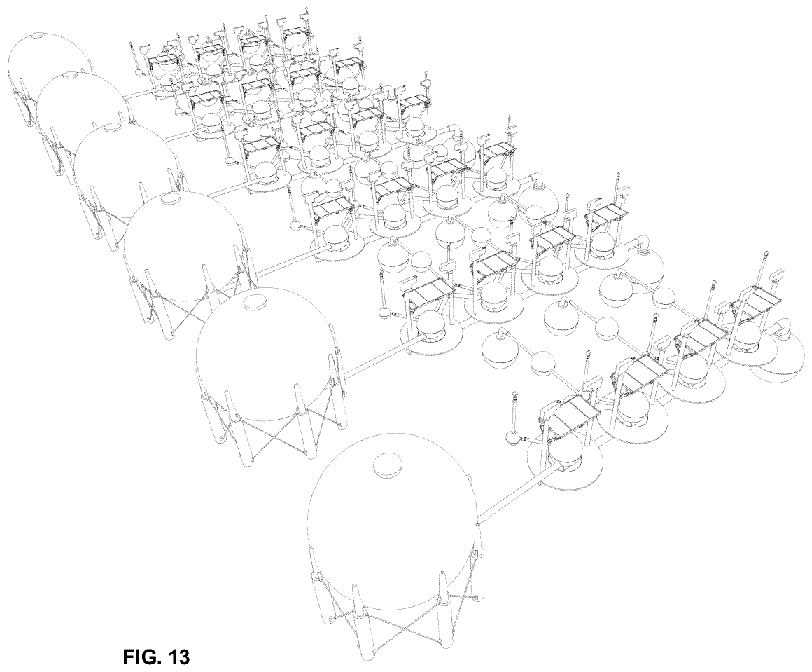

FIG. 12 and FIG. 13 show a layout, in which multiple of the units provided in FIGS. 9 to 11, are utilized to have a field of water heating units. The number of the units in each row and the number of rows may vary depending on several factors, including the amount of water supply available, the space available, the amount of clouds desired, the duration of sunlight available in that location, and the desired duration of operation of the system.

In operation, the water is supplied from the water reservoir to the water container. Using the lens, solar rays and solar energy are concentrated on the upper surface of the water container. This causes the heat inside the water container to rise and reach boiling temperature. Water is then converted to steam, which is then allowed to escape the water container through channels 6 and to be released through opening 6a to the atmosphere. The accumulation of such steam in the atmosphere above the system will cause the artificial formation of clouds. As the system continues to operate, more steam will be released to the atmosphere and the moisture in the clouds will continue to increase, which will lead to the formation of dense clouds, subject to favorable atmospheric conditions, including wind, temperature and air pressure.

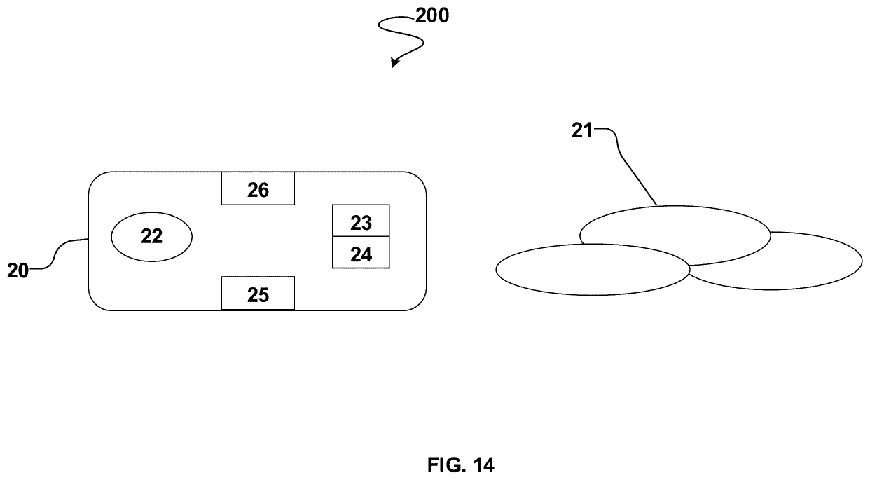

The second part of the system will now be described. Such second part of the system allows for repositioning the dense clouds formed by system 100. It is to be understood that such system may also be used to reposition naturally formed clouds as well to a desired position different from the position, where the clouds are naturally formed. The system utilizes the artificial manipulation of temperature in the atmosphere to manufacture low pressure systems, which causes the manufactured movement of the clouds to a desired location. FIG. 14 shows a schematic drawing of the second cloud repositioning system 200. An air vehicle 20 is shown to be positioned in proximity to a formed cloud 21. Air vehicle 20 may be a drone for example or other air vehicles known in the art capable of multi-directional maneuverability. Air vehicle is equipped with sensors 22 for measuring temperature, moisture, wind speed and air pressure as well as for determining the location and elevation of the air vehicle 20 via a global positioning system (GPS). The sensory data collected from sensors 22 are communicated to a processor 23, either via wired or wireless communication. In the current embodiment, processor 23 is shown to be located on air vehicle 20. In some embodiments, processor 23 is not located on air vehicle 23 and is located in a different location. In such embodiments, sensory data is communicated from sensors 22 to the processor 23 wirelessly. Processor 23 has a memory storage device 24, which is accessible by the processor. Memory storage device 24 may be integral or external to processor 23. The collected sensory data may be stored in memory storage device 24 along with other information, include weather conditions and atmospheric heat maps that is generated by weather networks or through previous surveys of the area by the air vehicle or other devices. Air vehicle 20 is also equipped with a heating mechanism 25, which is used for heating the atmosphere at the position of the air vehicle 20. In some embodiments, air vehicle 20 may be equipped with a cooling mechanism 26 for cooling the atmosphere at the position of the air vehicle 20.

In operation, air vehicle 20 is positioned in proximity to cloud 21. In some embodiments, air vehicle 20 may be positioned inside the formed cloud to determine the temperature, air pressure and moisture of the cloud through sensors 22. The air vehicle is then positioned outside the cloud and in proximity to it. The position of the air vehicle may be determined based on the GPS coordinates established by the GPS system onboard air vehicle 20. The data collected about the cloud is communicated to the processor. Additional sensory data is collected from the new position of the air vehicle also related to temperature, air pressure and moisture. Ideally, the new position of air vehicle 20 will have less moisture levels compared to the measurements obtained inside the cloud. The distance of the desired new position of air vehicle 20 compared to the position of the cloud may be calculated based on multiple factors, including wind speed, temperature and air pressure. At the new position of air vehicle 20, the processor 23 is configured to heat the atmosphere at the new position via heating mechanism 25. By heating the atmosphere, the air surrounding air vehicle 20 moves upward, forming a low pressure system at the position of air vehicle 20. Air from surrounding areas to air vehicle 20 then moves to that position. Due to the proximity to the cloud, this causes the cloud to move from its original position to the position of the artificially created low pressure system.

In some embodiments, depending on the size of the cloud, multiple air vehicles may need to be used to create a sufficiently sized low pressure system to relocate the entire cloud. The constellation of air vehicles 20 may take different configurations, which may be determined by a centralized processor 23 that governs the movement and operation of each air vehicle 20 in the constellation. Alternatively, each air vehicle will be operated by its own processor 23, where all processors 23 are synced or are configured to operate according to the same parameters.

If the new position of the air vehicle 20 is the ultimate desired location, then the objective of relocating the cloud to such desired location is achieved. If however the new position of the air vehicle 20 is not the ultimate desired destination, then the process is repeated by the air vehicle where data is collected from the cloud, the air vehicle is moved to a new location, calculated based on parameters as described above, the atmosphere is heated by the heating mechanism 25 at the new location to create a new low pressure system compared to the new position of the cloud. This in turn causes the cloud to move again from its new position to the next new position of the air vehicle. Such operation may continue in modular steps until the cloud is positioned to the ultimate final desire position in the atmosphere.

In some embodiments, processor 23 may map a movement path of the cloud from its original position to the ultimately desired end position. Such mapping may integrate information relating to existing heat maps of the atmosphere as well as wind direction and speed. Based on such data, processor 23 may determine the number of nodes required along the movement path for the air vehicle 20 to be positioned. As such, these nodes will determine the number of steps required by a single air vehicle or a constellation of air vehicles 20, where in each step a low pressure system is created compared to the location of the cloud as the cloud moves along the mapped path. In other embodiments, an air vehicle 20 or a constellation of air vehicles 20 may be placed at each of the nodes along the mapped movement path. In such embodiments, the heating operation of the atmosphere may be configured by the centralized processor 23 to occur in sequence to allow for the step-by-step movement of the cloud along the predetermined nodes along the movement path. In an alternative embodiment, a low pressure system may be created simultaneously at all nodes by the air vehicles 20 in each of the nodes' locations and a variance of the low pressure system is achieved by stopping the heating at the node, once the cloud is moved to that node. The determination of the movement of the cloud along the mapped path may be monitored by detection of the moisture levels at the air vehicles as well as by the monitoring of weather satellite data, which may be obtained from weather networks and communicated to processor 23.

The cloud relocation system described above provides for the use of air vehicles that allow for heating different locations of the atmosphere to create low pressure systems at such locations, which in turn causes the movement of the clouds to such locations. In some embodiments, it is possible to have a grid-like static structure of devices, suspended in the atmosphere at pre-determined positions, each of these devices having all sensors 22 mentioned above, as well as the heating mechanism 25 and the optionally cooling mechanism 26 onboard. In such embodiment, all remaining aspect of the system will be the same as described above with the stationary devices replacing the air vehicle and with exception of the movement associated with such air vehicles.

For ideal operation of the cloud relocation system described above, several factors and limitations have to be considered. For example, to create a low pressure system in the new location of the air vehicle or the node, the temperature in the new location needs to be equal to or less than the temperature of the existing position of the cloud. Also, to maintain the same variables across the different nodes and the location of the cloud, it is preferred that the movement path of the cloud be maintained substantially lateral to avoid introducing variance air pressure due to a change in elevation, which is usually associated with a change in temperature. However, such parameters may be compensated for as long as they are measured and accurately accounted for in the modeling of the path of movement of the cloud. Also, wind needs to be factored in for the use of the system (both for the cloud forming as well as for the cloud relocation). It is desired to plan the movement of the cloud along the direction of wind speed and not against it to maintain efficiency of operation and accuracy of results. Also, another factor for increasing efficiency is utilizing heat mapping of the area and mapping the movement path of the cloud to take advantage of same. For example, if the heat map shows a high temperature zone (i.e. a low pressure system) naturally forming in such zone, it would be efficient to incorporate that zone as a node along the movement path of the cloud. In such circumstance, no or minimal artificial heating would be required of such zone to allow the cloud to move to such location along the manufactured moving path of the cloud. In embodiments where air vehicles are used, it is recommended to have the location of such air vehicles communicated to air traffic control towers and airplanes to avoid any collisions. This may be achieved for example by having each air vehicle broadcast its own location on a known frequency. Alternatively, the processor 23 may be used to communicate the coordinates of the position of the air vehicles to air traffic control towers directly, or to communicate such information to a centralized server, which is accessible by air traffic control towers as well as planes.

Once the cloud is moved to the ultimate desire location, air vehicle 20 may be used to cool the temperature at that location to facilitate the forming of rain drops or snowflakes from the clouds and thereby triggering rainfall or snow fall in the desired location. In some embodiments, the air vehicle may also be equipped to spray silver iodide to aid in the seeding process.

The various embodiments of the cloud relocation system and methods of use described above allow for the passive relocation of the clouds by actively controlling the atmospheric conditions around the cloud, specifically the temperature and the air pressure, to facilitate movement of the cloud to a desired location in the atmosphere that is different from the original cloud's location. Such system allows for facilitating the presence of clouds in locations that are far away from location that have natural bodies of water, and hence locations where clouds are not likely to naturally occur. This allows for artificially providing such locations with rainwater, which may be used to nourish the lands in such locations and reduce expensive irrigation costs.

### Interpretation of Terms

Unless the context clearly requires otherwise, throughout the description and the claims:
“comprise,” “comprising,” and the like are to be construed in an inclusive sense, as opposed to an exclusive or exhaustive sense; that is to say, in the sense of “including, but not limited to”.
“connected,” “coupled,” or any variant thereof, means any connection or coupling, either direct or indirect, between two or more elements; the coupling or connection between the elements can be physical, logical, or a combination thereof.
“herein,” “above,” “below,” and words of similar import, when used to describe this specification shall refer to this specification as a whole and not to any particular portions of this specification.
“or,” in reference to a list of two or more items, covers all of the following interpretations of the word: any of the items in the list, all of the items in the list, and any combination of the items in the list.
the singular forms “a”, “an” and “the” also include the meaning of any appropriate plural forms.
“power source” and “power supply” refer to any source of electrical power in a form that is suitable for operating electronic circuits.
“user”, “subject”, “patient”, “individual” are understood to be used interchangeably in the disclosure and to refer to a bipedal animal, like a human.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, “upper”, “lower” and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

Where a component (e.g. a circuit, module, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of device and method have been described herein for purposes of illustration. These are only examples. The technology provided herein can be applied to device and method other than the examples described above. Many alterations, modifications, additions, omissions and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

It is therefore intended that the following appended claims and claims hereafter introduced are interpreted to include all such modifications, permutations, additions, omissions and sub-combinations as may reasonably be inferred. The scope of the claims should not be limited by the preferred embodiments set forth in the examples, but should be given the broadest interpretation consistent with the description as a whole.

What is claimed is:

1. A system for relocating clouds from an original location in the atmosphere to a predetermined location in the atmosphere, the system comprising:
a device having a power source and a heating mechanism powered by the power source and configured to heat the predetermined location in the atmosphere to a temperature higher than temperatures in locations neighboring the predetermined location, thereby creating a low pressure system in the predetermined location in the atmosphere compared to the original location of the clouds, the low pressure system causing the clouds to move from the original location to the predetermined location in the atmosphere.

2. The system according to claim 1, wherein the device is one or more air vehicles, each of the one or more air vehicles comprising:
one or more sensors for measuring a temperature, where the device is located, measuring an elevation of the device, and determining special coordinates of the device in the atmosphere using a global positioning system (GPS).

3. The system according to claim 2, the system further comprising: a processor in data communication with the one or more sensors, the processor is powered by a power supply and having a storage device, on which measurements from the one or more sensors are stored and accessible by the processor, the processor configured for mapping a path of movement of the clouds from the original location to the predetermined location in the atmosphere based on data collected from the one or more sensors.

4. The system according to claim 3, wherein the path of movement of the clouds from the original location to the predetermined location in the atmosphere includes one or more nodes, wherein the one or more sensors are configured to obtain sensory data at each of the one or more nodes and wherein the device is configures to create a low pressure system at each of the one or more nodes, when the device is positioned at the one or more nodes, thereby causing the clouds to move from the original location to the predetermined location incrementally along each position of the one or more nodes.

5. The system according to claim 2, wherein the device is a plurality of air vehicles forming a constellation, wherein all air vehicles in the constellation are synchronized to work in unison to establish a low pressure system sufficient in size to move the clouds from the original position to the predetermined position.

6. The system according to claim 4, wherein the device is a plurality of air vehicles forming a constellation, wherein each air vehicle in the constellation is configured to occupy a position of the one or more nodes and wherein all air vehicles in the constellation are synchronized to work in unison to establish a low pressure system sufficient in size to move the clouds incrementally from the original position to the predetermined position along the path formed by the one or more nodes.

7. The system according to claim 1, wherein the device is a series of stationary pods forming a grid structure, wherein each pod in the stationary pods is suspended in a predetermined pod location in the atmosphere and wherein each pod comprises one or more sensors for measuring a temperature, where the pod is located.

8. The system according to claim 7, the system further comprising: a processor in data communication with the one or more sensors in each of the pods, the processor is powered by a power supply and having a memory storage device, on which measurements from the one or more sensors from each pod are stored and accessible by the processor, the processor configured for mapping a path of movement of the clouds from the original location to the predetermined location in the atmosphere based on data collected from the one or more sensors from each of the pods, and wherein the path of movement of the clouds from the original location to the predetermined location in the atmosphere includes one or more nodes corresponding in special location to some of the stationary pods in the constellation of pods.

9. A system for forming clouds in the atmosphere artificially, the system comprising:
a water container for housing water;
at least one lens positioned above the water container for concentrating sunrays on at least part of the surface of the water container and heating the water inside the water container to convert the water to steam; and
a steam channel fluidically coupled to the water container, the steam channel configured to allow the steam generated in the water container to escape to the atmosphere;
wherein the clouds are artificially formed in the atmosphere on demand by the steam escaped from the steam channel.

10. The system according to claim 9, wherein the at least one lens is supported by a lens frame, the system further comprising controls for controlling elevation and orientation of the lens frame, the controls mounted on a structural frame for supporting the controls, the lens frame and the at least one lens above the water container.

11. The system according to claim 10, wherein the system further comprises an inlet channel fluidically coupled to the water container and is configured for supplying the water from a water reservoir to the water container; and an inlet pump for pumping the water from the water reservoir to the water container.

12. The system according to claim 11, wherein a heating unit is defined to have the water container, the at least one lens, the lens frame and the structural frame, and wherein the system comprises a plurality of heating units.

13. The system according to claim 12, the system further comprises a network of secondary channels configured to fluidically couple all of the water containers in the plurality of heating units in the system.

14. The system according to claim 9, the system further comprising a desalination unit, the desalination unit comprising a desalination channel, a cooling chamber and a desalinated water container, wherein the desalination channel directs the steam from the water container to the cooling chamber for condensing the steam into water, and wherein the condensed water is stored in the desalinated water container.

15. The system according to claim 9, the system further comprising a steam turbine housed in a compartment that is fluidically coupled to the steam channel and wherein the steam is passed through the steam turbine before escaping to the atmosphere, thereby generating electricity.

16. The system according to claim 10, the system further comprising a lens cover configured for covering the at least one lens and shielding the at least one lens from sunrays, thereby stopping heat access to the water container.

17. The system according to claim 1, wherein the clouds that are relocated are formed naturally or formed artificially in accordance with the system of claim 5.

18. A method of relocating clouds in the atmosphere from an original position to a predetermined position in the atmosphere, the method comprising:
heating the predetermined positing in the atmosphere to a temperature higher than temperatures of neighboring positions in the atmosphere, including the original position; and
creating a low pressure system at the predetermined position, the low pressure system causing the clouds to move from the original position to the predetermined position.

19. The method according to claim 18, the method further comprising mapping a path of movement of the clouds from the original position to the predetermined position in the atmosphere based on sensory data relating to temperature, elevation and positioning of the original position and the predetermined position.

20. The method according to claim 19, wherein the mapping of the path of movement of the clouds comprises mapping one or more nodes along the path of movement and incrementally moving the clouds from the original position to the predetermined position along the one or more nodes by creating a low pressure system at each one of the one or more nodes.
